(19) United States
(12) Patent Application Publication
(10) Pub. No.: US 2024/0149679 A1
(43) Pub. Date: May 9, 2024

(54) ROAD VEHICLE EQUIPPED WITH CONCAVE CURVED CONTENT DISPLAY

(71) Applicant: FERRARI S.P.A., Modena (IT)

(72) Inventors: Jonathan P. IVE, SAN FRANCISCO, CA (US); Eugene WHANG, SAN FRANCISCO, CA (US); Jeremy BATAILLOU, SAN FRANCISCO, CA (US); Anthony ASHCROFT, SAN FRANCISCO, CA (US); Suhang ZHOU, SAN FRANCISCO, CA (US); Benoit LOUZAOUEN, SAN FRANCISCO, CA (US); Jemima KISS, SAN FRANCISCO, CA (US); Christopher WILSON, SAN FRANCISCO, CA (US); Wan Si WAN, SAN FRANCISCO, CA (US); Biotz NATERA, SAN FRANCISCO, CA (US); James MCGRATH, SAN FRANCISCO, CA (US); Roger GUYETT, SAN FRANCISCO, CA (US); Joseph LUXTON, SAN FRANCISCO, CA (US); Michael MATAS, SAN FRANCISCO, CA (US); Patrick KESSLER, SAN FRANCISCO, CA (US); Patrizio MORUZZI, MODENA (IT); Vito CONIGLIARO, MODENA (IT)

(21) Appl. No.: 18/498,513

(22) Filed: Oct. 31, 2023

(30) Foreign Application Priority Data
Nov. 4, 2022 (IT) 102022000022662

(51) Int. Cl. B60K 35/22; B60K 35/50; B60K 35/65; B60K 35/80

(52) U.S. Cl. CPC B60K 35/22; B60K 35/50; B60K 35/654; B60K 35/656; B60K 35/80

(57) ABSTRACT

A road vehicle comprising a passenger compartment configured to accommodate a driver and at least one passenger alongside the driver; a vehicle dashboard; a content display device comprising a support element mounted centrally at the dashboard of the road vehicle; at least one screen, mechanically connected to the support element and configured to be visible to a passenger and to a driver while driving; the screen has a curved shape and is horizontally divided into a first portion 11 and a second portion 12, which are respectively visible, in a substantially mutually exclusive manner, to the driver DR and to the passenger P.

### CROSS-REFERENCE TO RELATED APPLICATIONS

This patent application claims priority from Italian patent application no. 102022000022662 filed on Nov. 4, 2022, the entire disclosure of which is incorporated herein by reference.

### TECHNICAL FIELD

The present invention concerns a road vehicle provided with a content display device.

In particular, the present invention is advantageously, but not exclusively, applied in a high-performance road vehicle, to which the following description will explicitly refer without loss of generality.

### BACKGROUND TO THE INVENTION

Generally, road vehicles are provided with a plurality of display devices arranged on the dashboard of the road vehicle.

Historically, each road vehicle comprises at least one display device for the driver, for example the screens or indicators arranged on the vehicle instrument panel, namely on the portion of dashboard interposed between the steering wheel and the windscreen.

In recent years, said devices can be assisted by other screens (for example at least one screen arranged centrally on the dashboard or a head-up display) which complete display of the information for the driver.

In general, the arrangement of a increasingly large central screen is becoming increasingly popular, especially in fully electric cars; however, in the majority of cases, said central screens are exclusively provided with touch controls which, during sports car driving (for example on the track), make it difficult, if not impossible, to select a function without distracting the driver. Furthermore, said screens are generally integral with the dashboard and therefore, whilst they are visible both to the driver and to the passenger, they do not provide an optimal view of the information for either of them both in terms of perspective and due to possible reflections (for example caused by the sun or the headlights of another vehicle), which considerably reduce the rapidity with which the driver can read said information.

In addition, although devices have been developed designed to be visible also to the passengers of road vehicles, said devices are generally associated with the rear seats, since it is difficult for a passenger sitting in the front seat, alongside the driver, to view distracting content such as films, documentaries, news, etc. without distracting the driver. For this reason, it is difficult for the front passenger to view distracting content via the central screen.

In recent years, to overcome the problem of driver distraction, the front passenger is allowed to view distracting content only with the vehicle at a standstill. During driving, on the other hand, the front passenger is allowed to view only content deemed to be non-distracting, for example the speed, route or other contents that aid driving (such as the current gear, lateral accelerations) which, for example, the driver can view via other screens.

However, said solutions limit the entertainment of the front passenger (namely the passenger sitting alongside the driver), reducing the pleasure of the ride.

In general, therefore, the need is felt to increase the flexibility of the vehicle display systems, allowing the driver to read the information more rapidly and, at the same time, enabling the passenger to view distracting content.

### DESCRIPTION OF THE INVENTION

The object of the present invention is to provide a road vehicle equipped with a content display device which is at least partially exempt from the drawbacks described above and, at the same time, is simple and inexpensive to produce.

According to the present invention, a road vehicle equipped with a content display device is provided as claimed in the following independent claims and, preferably, in any one of the claims depending directly or indirectly on the independent claims.

The claims describe preferred embodiments of the present invention forming an integral part of the present description.

### BRIEF DESCRIPTION OF THE DRAWINGS

Below, some embodiments of the invention will be described for a better understanding thereof by way of non-limiting example and with reference to the attached drawings in which:

FIG. 1 is a perspective schematic view, with details removed for clarity, of a possible embodiment of a road vehicle in accordance with the present invention;

FIG. 2 is a perspective schematic view of part of the interior of the passenger compartment of the vehicle of FIG. 1 in which a central display device can be seen in one embodiment.

### EMBODIMENTS OF THE INVENTION

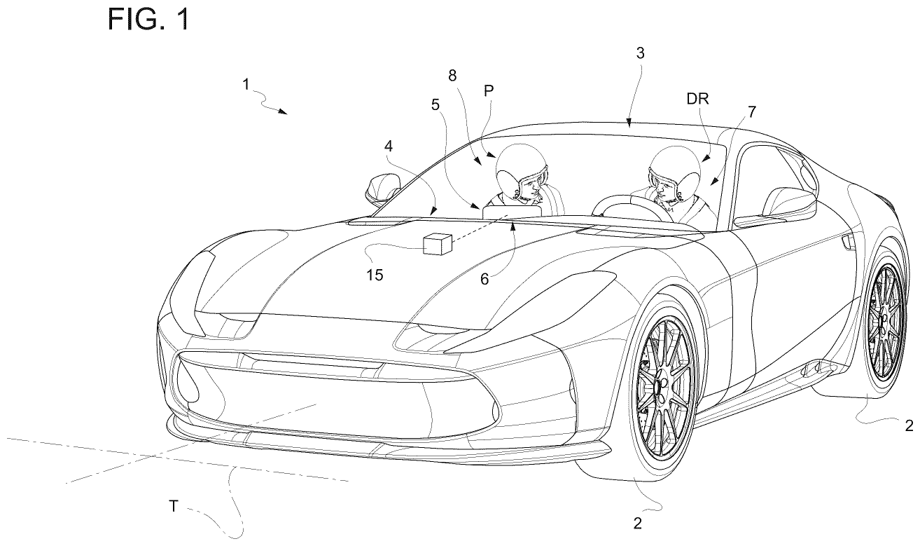

In FIG. 1, the number 1 indicates overall a road vehicle provided with two front wheels 2 and two rear wheels 2 (in particular driving wheels). The vehicle 1 is provided with a passenger compartment 3 which is adapted to house at least one driver DR and preferably one or more passengers P, of which at least one alongside the driver DR as illustrated in FIG. 1. The same reference numbers and letters in the figures identify the same elements or components with the same function.

In the context of the present description the term “second” component does not imply the presence of a “first” component. Said terms are employed as labels to improve clarity and should not be understood in a limitative manner.

The elements and the characteristics illustrated in the different preferred embodiments, including the drawings, can be combined with or isolated from one another without departing from the protective scope of the present application as described below.

Furthermore, the road vehicle 1 comprises a frame (of known type and therefore not illustrated in detail), and a vehicle dashboard 4 inside the passenger compartment and fixed to the frame. The vehicle dashboard 4 is arranged frontally to the driver DR and to any passenger P.

As illustrated in the non-limiting embodiments of the attached figures, the road vehicle 1 comprises a content display device 5, which is arranged at the vehicle dashboard 4, in particular on a central portion 6 of the vehicle dashboard 4 between a driving position 7 and a passenger position 8.

The content display device 5 comprises a support element 9, which is configured to be mounted on the central portion 6. The support element 9, in other words, determines the main structure of the content display device 5, namely the portion on which the other components of the device 5 are mounted/assembled.

Furthermore, the display device 5 comprises a screen 10, which is mechanically connected to and preferably integral with the support element 9 and is configured to be visible to the driver DR and/or to the passenger P. The screen 10 is of known type (for example liquid crystal and preferably a touch screen) and therefore is not further described below.

Advantageously, the content display device 5, in particular the screen 10, more in particular the support element 9, has a curved shape, in particular determined by a developable surface (namely a surface that can be created from a flat sheet). Preferably, the content display device 5 has a cylindrical curved shape, namely corresponding ideally to a portion of the lateral surface of a cylinder. In other words, if the display device 5 were straightened, a rectangle would be obtained.

Advantageously, the display device 5, in particular the screen 10, is configured so as to have an axis of curvature (namely the axis whose points are equidistant from the screen 10) transverse to a transverse axis T of the road vehicle. In particular, preferably, the axis of curvature is substantially vertical or in any case belongs to a plane that longitudinally cuts through the road vehicle 1.

Preferably, the display device 5, in particular the screen 10, is horizontally divided into a first portion 11 and a second portion 12, which can be respectively viewed, exclusively, by the driver DR and by the passenger P.

In detail therefore, the curvature of the screen 10 is such as to prevent the driver DR (assuming a conventional driving position) from seeing the second portion 12 and the passenger P (assuming a conventional position) from seeing the first portion 11.

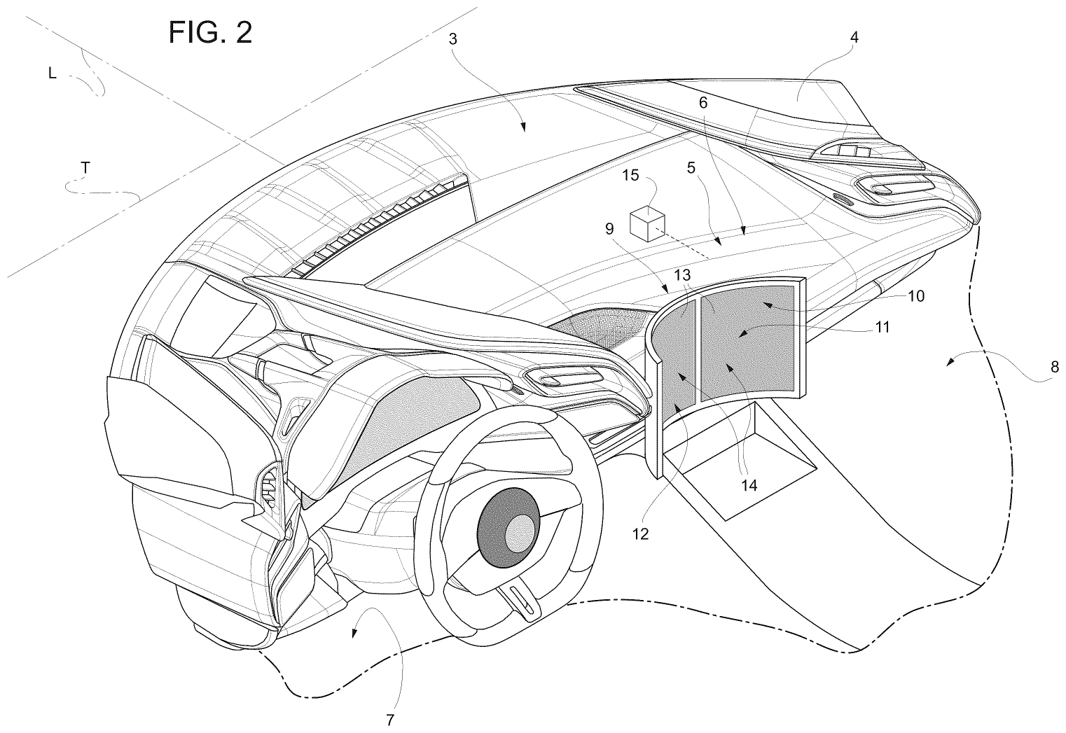

In some non-limiting cases, like the one illustrated in FIG. 2, the display device 5 is curved so as to direct the concavity towards the centre of the passenger compartment 3, namely towards the driver DR and the passenger P. In said case, the first portion 11 visible to the driver is a right-hand portion, while the second portion 12 visible to the passenger P is a left-hand portion.

In other non-limiting cases not illustrated, the display device 5 is curved so as to direct the convexity towards the centre of the passenger compartment 3, namely towards the driver DR and the passenger P. In said case, the first portion 11 visible to the driver is a left-hand portion, while the second portion 12 visible to the passenger P is a right-hand portion.

According to some non-limiting embodiments, the screen 10 comprises both the first portion 11 and the second portion 12.

According to other non-limiting embodiments, the screen 10 comprises two sub-screens 13 which, relatively to a longitudinal axis L of the road vehicle 1, are preferably arranged one on the right and one on the left of the axis L.

Preferably but without limitation, the first portion 11 and the second portion 12, and therefore, if necessary, the two sub-screens 13, are provided with the same surface 14 for the representation of images.

In other non-limiting embodiments not illustrated, the first portion 11 and the second portion 12 have different dimensions, and/or the screen 10 is arranged asymmetrically relative to the longitudinal axis L of the vehicle 1.

According to some preferred non-limiting embodiments, the road vehicle 1 further comprises a control unit 15, which is configured to vary the contents shown by the display device 5 between the first portion 11 and the second portion 12.

In particular, the control unit 26 commands the screen 10 to show in the first portion 11 driving-related content, for example a route, the speed, lateral acceleration, lap time, etc. The control unit 26 commands the screen 10 to show in the second portion 12 also distracting content such as videos, games, films, etc.

In use, while driving, the driver DR can easily view the first portion 11 simplifying reading of the vehicle data, minimizing distraction from the track, for example. In the same way, the passenger P can view in the second portion 12 distracting content, enabled only for the part of the screen 12 not visible (without non-conventional movements) to the driver DR, who therefore cannot be distracted.

Although the invention described above makes particular reference to a precise embodiment example, it should not be considered limited to said embodiment example, since its scope includes all the variations, modifications or simplifications covered by the attached claims such as, for example, a different type of road vehicle (for example with front wheel drive), a different shape of the passenger compartment, a different type of screen, an extreme V curvature of the screen 10, etc.

The vehicle and the display device described above have numerous advantages.

Firstly, they reduce distraction of the driver when viewing the vehicle data and information, and when using the mechanical controls.

Furthermore, at the same time, the passenger can be entertained with content that would otherwise be distracting for the driver and should therefore be generally precluded during driving.

### LIST OF REFERENCE NUMBERS OF THE FIGURES

1 vehicle
2 wheels
3 passenger compartment
4 dashboard
5 display device
6 central portion
7 driving position
8 passenger position
9 support element
10 screen
11 first portion
12 second portion
13 sub-screens
14 surface for representation of images
15 control unit
DR driver
L longitudinal axis
P passenger
T transverse axis

1. A road vehicle (1) comprising
four wheels (2), of which at least one pair of wheels (2) is a pair of driving wheels;
a passenger compartment (3) configured to accommodate a driver (DR) and at least one passenger (P) alongside the driver (DR);
a vehicle dashboard (4);
a content display device (5);
the content display device (5) comprising:
a support element (9) mounted centrally at the dashboard (4) of the road vehicle (1);
at least one screen (10), mechanically connected to the support element (9) and configured to be visible to a passenger (P) and to a driver (DR) while driving;
the road vehicle (1) being characterized in that the screen (10) has a curved shape and is horizontally divided into a first portion (11) and a second portion (12), which are visible respectively, in a substantially mutually exclusive manner, to the driver (DR) and to the passenger (P).

2. The road vehicle (1) according to claim 1, wherein the screen (10) has a developable surface, in particular rectangular.

3. The road vehicle (1) according to claim 1, wherein the screen (10) is configured so as to have an axis of curvature, the points of which are equidistant from the screen (10) transverse to a transverse axis (T) of the road vehicle (1); in particular, the axis of curvature belongs to a plane that longitudinally cuts through the road vehicle (1).

4. The road vehicle (1) according to claim 1, wherein the screen (10) directs the concavity towards the centre of the passenger compartment (3).

5. The road vehicle (1) according to claim 4, wherein the first portion (11) of the screen (10) visible to the driver (DR) is a right-hand portion, while the second portion (12) of the screen (10) visible to the passenger (P) is a left-hand portion.

6. The road vehicle (1) according to claim 1, wherein the screen (10) comprises two sub-screens (13) which, relative to a longitudinal axis (L) of the road vehicle (1), are preferably arranged one on the right and one on the left of the axis (L).

7. The road vehicle (1) according to claim 1 and comprising a control unit (15), which is configured to vary the contents shown by the display device (5) between the first portion (11) visible to the driver (DR) and the second portion (12) visible to the passenger (P).
